(19) United States
(12) Patent Application Publication
(10) Pub. No.: US 2009/0158666 A1
(43) Pub. Date: Jun. 25, 2009

(54) SAFETY GATES

(76) Inventors: Stephen Alexis Atkinson, Blackburn Lancashire (GB); Steven Catterall, Blackburn Lancashire (GB)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/301,200

(22) PCT Filed: May 10, 2007
(86) PCT No.: PCT/GB2007/050253

§ 371 Date: Feb. 13, 2009

(30) Foreign Application Priority Data
May 17, 2006 (GB) 0609765.3
Jan. 23, 2007 (GB) 0701239.6

(51) Int. Cl. E06B 9/01

(52) U.S. Cl. 49/55; 49/50

(57) ABSTRACT

Improvements in and relating to safety gates Disclosed is a safety gate assembly for positioning on a step of a flight of stairs and for impeding access to the flight of stairs, the assembly comprising: a frame, arranged to span an entry to the flight of stairs; and a gate, attached to the frame and movable between a closed position, where access to the flight of stairs is barred, and 10 open position, where the stairs are accessible, an wherein the frame comprises a pair of substantially upright, generally parallel, members for engagement with parts of the flight of stairs and/or the wall or walls adjacent to it, and a substantially horizontal member, linking the upright members such that the frame is generally u-shaped and the substantially horizontal member is arranged to be positioned, in use, below the surface of the step.

Safety gates for preventing access to the top and/or the bottom of a staircase are commonly used in households with small children who might otherwise gain access to the stairs and potentially come to harm.

Prior art stair gates tend to fall into one of two categories: permanently fixed gates requiring the gate components to be screwed or otherwise fixed to the walls and/or banisters; or temporary gates, which can be fitted easily but do not cause any permanent damage to walls or woodwork.

Each type of gate has its advantages and disadvantages. The permanent type tends to be more robust but requires a certain level of DIY ability to fix it in place and it can leave holes in walls and brickwork which need repairing when the gate is eventually removed.

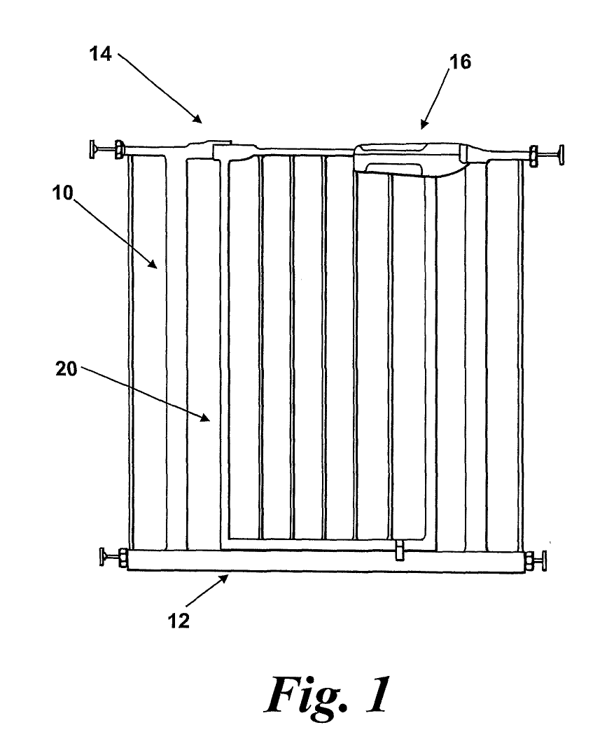

The temporary type, shown in FIG. 1, may be fitted easily with no tools or specialist knowledge required but, as the gates require a pressure fit alone to keep them in position, they can be more flimsy and can work loose. Perhaps the biggest single disadvantage with the temporary type of gate is that since the frame 10 in which the gate 20 sits must be complete on three sides of a rectangle, there is always a lower bar or rail 12, which can pose a trip hazard, particularly to tired parents who have to negotiate staircases in darkness to tend to crying children in the night. Of course, the same risk of tripping is present to children when they use the gates under adult supervision.

FIG. 1 also shows how the gate pivots about hinge 14 and is provided with a lock 16 to ensure that it cannot be opened by a child.

It is an aim of embodiments of the present invention to address the problems inherent in prior art stair gates of all types, whether mentioned herein or not. In particular, it is an aim of embodiments of the invention to provide a stair gate which is easy to fit and minimises the possibility of tripping.

According to the present invention there is provided an apparatus as set forth in the appended claims. Preferred features of the invention will be apparent from the dependent claims, and the description which follows.

For a better understanding of the invention, and to show how embodiments of the same may be carried into effect, reference will now be made, by way of example, to the accompanying diagrammatic drawings in which:

FIG. 1 shows a prior art stair gate of the temporary, pressure-fit variety;

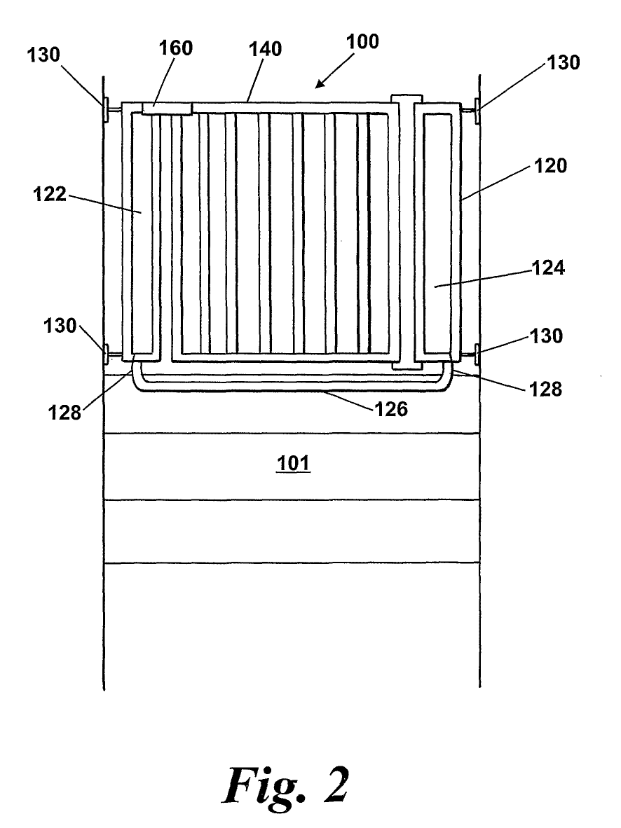

FIG. 2 shows a front view of a first embodiment of the present invention;

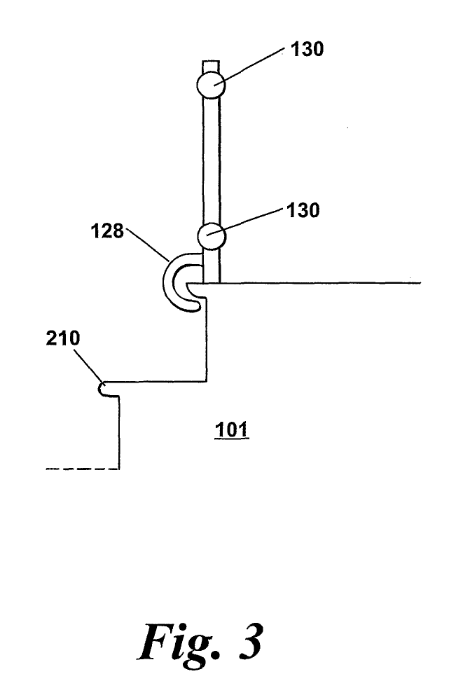

FIG. 3 shows a side view of the first embodiment;

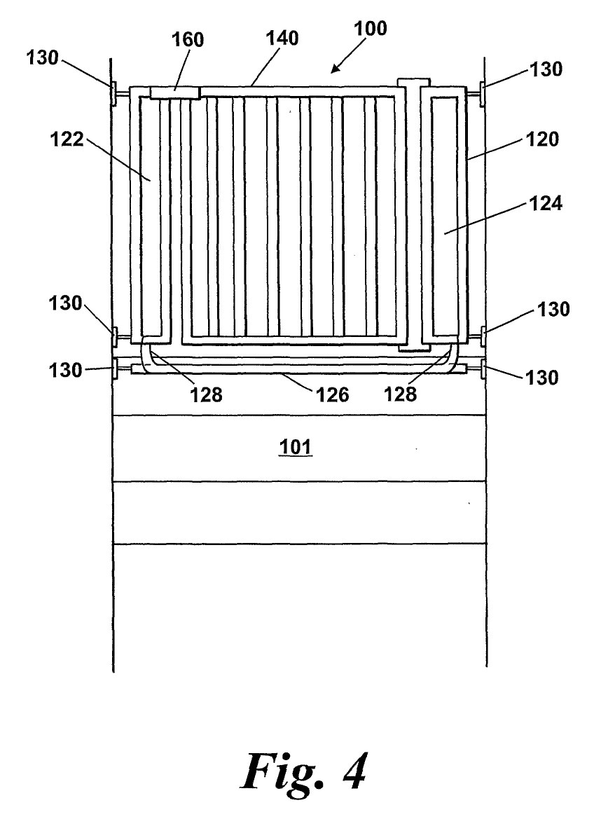

FIG. 4 shows a front view of a second embodiment of the present invention;

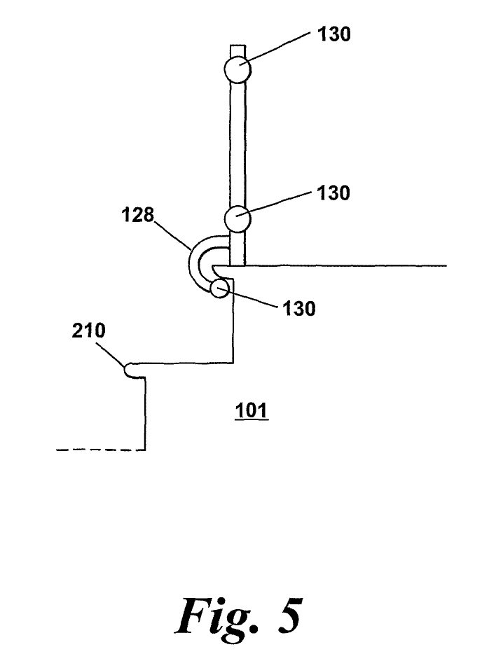

FIG. 5 shows a side view of the second embodiment;

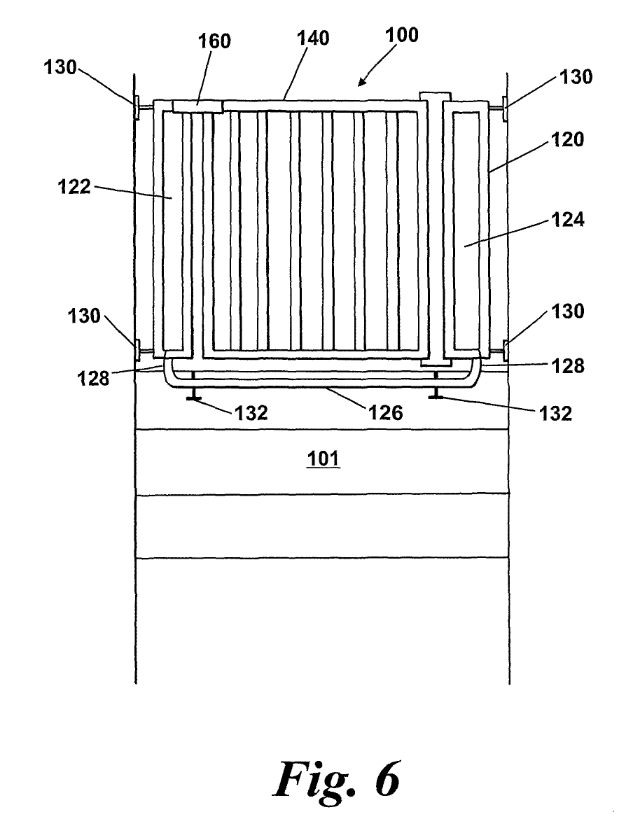

FIG. 6 shows a front view of a third embodiment of the present invention; and

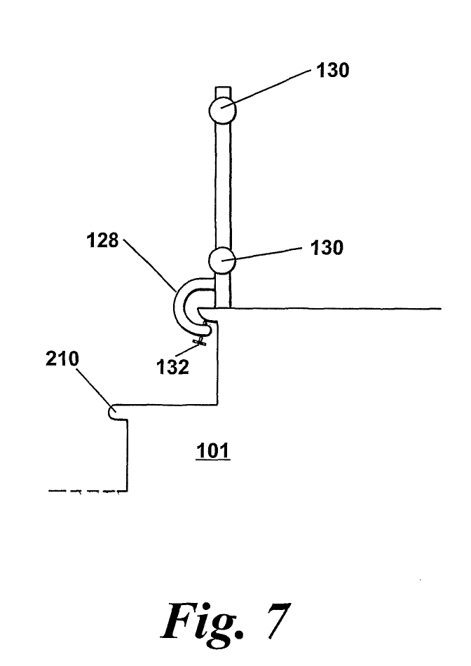

FIG. 7 shows a side view of the third embodiment;

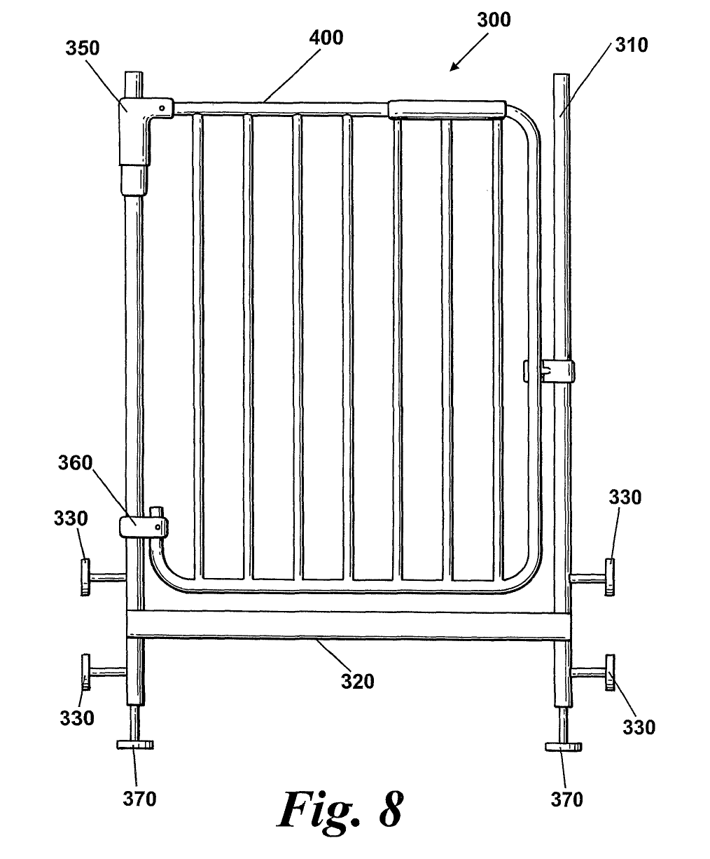

FIG. 8 shows a front view of a fourth embodiment of the present invention;

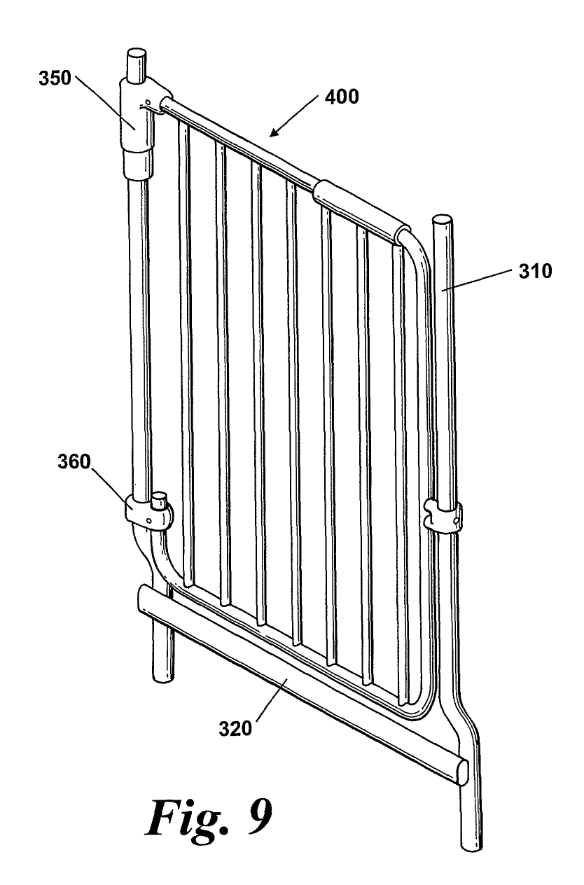

FIG. 9 shows a perspective view of a fourth embodiment of the present invention; and

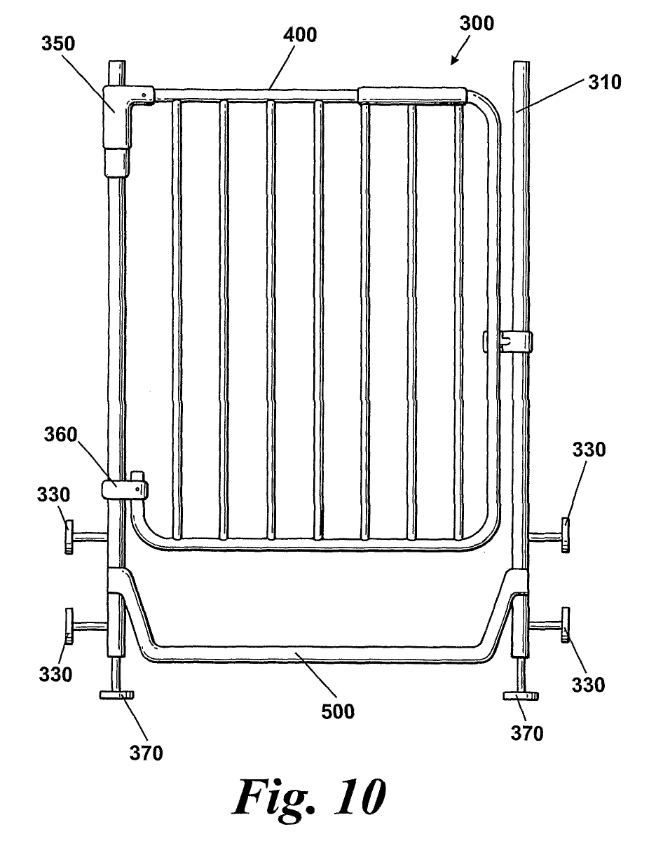

FIG. 10 shows a perspective view of a fifth embodiment of the present invention.

FIG. 2 shows a stair gate 100 according to a first embodiment of the present invention. The stair gate 100 is of the type that is intended to be fitted temporarily and without causing permanent damage to the adjacent walls, staircase 101, newel post or banisters. The stair gate 100 is secured in position using a pressure-fit arrangement similar to that used in prior art stair gates, such as the one shown in FIG. 1.

The stair gate comprises two main components: a frame 120 and a gate 140. The gate 140 is connected to the frame using one or more hinges so that the gate 140 is able to move easily between a closed and open position relative to the frame 120.

The gate comprises a plurality of vertical or horizontal members spaced in such a way that there is no danger of a child's head becoming trapped between adjacent bars. A solid-bodied gate could also be provided.

The gate 140 is arranged such that it can only open in a single direction. For example, for a gate to be positioned at the top of a flight of stairs, the gate is arranged to only open onto the landing and not out onto the steps. The direction of opening can be set at the time of installation so that any gate can be configured to open in only a single direction or, if chosen, in both directions. The act of setting the direction may comprise fitting a pin in the hinge or some other simple mechanical solution.

Gates according to an embodiment of the invention may be used at the top or bottom of staircases. While it is common to install a gate at the top of a staircase, it is important that a further gate is installed at the bottom so that a child cannot climb the staircase and then fall from there.

The gate 140 is able to be locked in the closed position so that access to the stairwell 101 is barred when the gate is closed. The lock 160 is arranged to be easily operated by an adult but difficult or impossible for a small child to operate, ensuring that children are not able to gain access to the stairwell.

The lock 160 may be attached to the frame 120 or the gate 140, as required. A variety of types of lock are used in prior art stairgates and any one of these could be utilised in an embodiment of the invention.

The frame 120 essentially comprises two upright members 122, 124 and a horizontal member 126 arranged generally in a U-shape with the two upright members 122, 124 being generally parallel to each other and the bounding walls or banisters, and the horizontal member 126 being generally perpendicular to each of the upright members 122, 124 and lying at a lower part of the stairgate 100.

At the upper and lower portions of each upright member 122, 124 is a pressure-fit member 130. Each pressure-fit member 130 comprises a screw arranged within a complementary threaded portion of the frame 120. The outermost part of the screw is capped with a pad comprising a rubber or plastics material for contacting the supporting surface.

To attach the frame to the top or bottom of the staircase, the frame is arranged to block the passageway formed by either a wall on each side of the stairs, a wall and a banister or two banisters. In the following exemplary situation, it is assumed that the staircase in question is bounded on one side by a wall and on the other by a banister rail. However, the other configurations mentioned above, or others, operate in a similar way.

The frame is arranged between the wall and newel post at the end of the banister rail. Each pressure-fit member is then screwed out of its housing so that its pad is extended outwards, towards either the wall or newel post respectively. When each member 130 has been sufficiently adjusted, the frame 120 is held securely in place.

A spanner may be required in some configurations to ensure that a secure fit is achieved. A double bolt arrangement may be used so that the pressure-fit members are locked in position, whereby the first bolt locks the screw thread in position and the second bolt stops the first bolt loosening.

Other pressure-fit arrangements are possible, such as toggle clamps, geometric clamps, ratchet mechanisms and hydraulic clamps, which require hand pumping to secure. Unlike the prior art gate of FIG. 1, the horizontal member 126 is not arranged to lie on the tread immediately beneath the lower portion of the gate 140. Rather, it is arranged at the end of two short sections 128 which each extend out from the gate and curve around the exposed edge or nose of the tread of the step on which the gate 100 is mounted. This is shown clearly in the side view of FIG. 3.

The horizontal member 126 is thus able to be located below the tread of the step on which the gate is mounted, removing or at least minimising its potential to act as a trip hazard.

Preferably, the profile of the short members 128 can be configured to be generally hook-shaped or arcuate in shape so that the horizontal bar 126 can sit under the ‘nose’ 210 which is present on many stair treads.

The cross-sectional profile of horizontal bar 126 may be configured such that it presents a gently sloping angled surface which acts to avoid any sudden changes in profile of the riser below the step on which the gate is mounted.

By providing such a profile, if someone walking up the stairs contacts the bar 126, the possibility of them tripping on the sudden discontinuity which would otherwise be present, is reduced.

The frame 120 and gate 140 are suitably manufactured from welded tubular steel, pressed steel, extruded aluminium, cast aluminium, extruded/moulded plastics material (such as glass reinforced nylon), formed plywood or other suitable material.

By arranging the components of the stair gate in this way, the lower horizontal bar, which is required in all pressure-fitting stairgate arrangements to provide a solid base, can be located in a position where it does not generally interfere with motion up or down the stairs. This removes the potential of accidentally tripping over or stepping on the lower bar, which can be painful and/or dangerous and which is one of the reasons why many potential customers are reluctant to buy the temporary style of gate.

FIGS. 4 and 5 show a second embodiment of the invention which is essentially a variant of the first embodiment. The only difference between the first and second embodiments is that the second embodiment includes two further pressure-fit members 130 located at each outer end of the lower horizontal bar 126. These extra members 130 are arranged to provide even further stability to the frame 120 and may be used or not depending on the mechanical properties of the material used to construct the frame.

Embodiments of the invention are compatible with all types of staircase. Staircases of the open type, that have no risers and merely consist of a series of treads supported in strings on either side, are particularly suitable for use with embodiments of the invention as the lower bar 126 can be completely hidden in the gap under the tread.

A third embodiment of the present invention, shown in FIGS. 6 and 7 is intended to be used specifically on open staircases, referred to above. This embodiment closely resembles the first embodiment but includes further fastening means 132, disposed on the lower horizontal bar 126.

The fastening means 132 each comprise a screw member arranged to engage with a complementary threaded portion of the bar 126 and to fully protrude through the bar. In use, the gate 100 is fastened in position as described previously and, to provide further security, the fastening means 132 are tightened to securely grasp the tread of the step as shown in FIG. 7.

FIG. 8 shows a stair gate according to a fourth embodiment of the present invention. Stair gate 300 is of the type that is intended to be fitted temporarily and without causing permanent damage to the adjacent walls, staircase, newel post or banisters. The stair gate 100 is secured into position using a pressure fit arrangement similar to that already described.

The stair gate comprises two main components: a frame 300 and a gate 400. The gate 400 is connected to the frame using one or more hinges so that the gate 400 is able to move easily between the closed and open position, relative to the frame 300. The frame comprises a pair of substantially vertical upright members 310 which are joined together towards their lower ends by a substantially horizontal section 320. The horizontal section is welded into place to ensure mechanical strength. Alternatively, it may be formed as a one-piece casting, bolted or otherwise secured.

As can be seen from FIG. 9, the lower portions of the upright members 310 are angled away from the vertical so that the lower horizontal member 320 can be positioned just below the flat surface of the tread of a stair. In this way, the lower bar 320 does not pose a trip hazard when the gate is opened, as it positioned substantially adjacent to the riser below the tread on which the stair is mounted.

In the prior art stair gate of FIG. 1, the actual aperture through which a user can pass is relatively narrow and substantially narrower than the space in which the gate is mounted. This is due to the fact that the structural integrity of the gate is maintained by the relatively wide upright members of substantially U-shaped configuration of the frame 10, which is required to ensure that the pressure fitting devices provide sufficient force to hold the gate in position.

In contrast, this and other embodiments are able to offer a much wider access aperture since the need for such a large external frame is substantially avoided.

To secure the gate in position, the frame 300 is positioned to stand on a suitable step or floor surface. Height adjusters 370 may be provided at the lower end of the up the upright members 310. These consist of a simple screw thread with a flat foot portion which can be adjusted such that the horizontal bar 320 is positioned just below the edge of the step where access is required. Once the height adjusters 370 have been suitably adjusted, pressure fitting arrangements 330 are adjusted to secure the gate firmly in position, as described previously. In the embodiment shown in FIG. 8, four such pressure adjusters 330 are provided. There are two pressure adjusters 330 provided on each of the upright members 310, with one such adjuster being positioned just above the horizontal bar 320 and the other being positioned just below it. By adjusting the pressure fit arrangement 330, which consists of a threaded screw terminated in a foot of rubber or similar soft material, to contact the walls and/or staircase, it is possible to securely fasten the gate in position. The pressure applied by the lower pair of pressure fit arrangements 330 tends to push the lower portions of the upright members 310 inwards, towards each other. The action of the pressure fit arrangements 330 positioned above the horizontal member 320 tends to push the upper portions of the vertical upright members 310 inwards towards each other.

By carefully tightening each pressure fit attachment 330, it is possible to ensure that this inwards pressure is substantially directed along the horizontal member 120 only, which ensures that the gate can be held securely in position by use only the four pressure fit arrangements described. This arrangement allows greater pressure to be applied, thus holding the gate more securely in place, than is possible using prior art arrangements.

A problem in many houses, particularly those built recently, is that walls and staircases are often of a dry-lined or stud-partition construction. This can mean that the act of fitting a safety gate using pressure-fit attachments to such walls, can result in holes being punched in the wall material, damaging the finish of the wall and resulting in a less stable fit for the safety gate. Furthermore, fixing a safety gate of the type requiring permanent fixings requires the use of special cavity fixings, which can be problematic.

Embodiments of the present invention, particularly as shown in FIG. 8, can alleviate this problem, by ensuring that the pressure fit attachments are arranged to contact and press against the stair stringers—the wooden members which support the stairs and which run alongside them abutting the walls on either side of the staircase. In this way, damage to the plaster can be avoided.

However, to provide extra fitting security, it may be desirable in some cases to provide further pressure fit attachments 130 (not shown in FIG. 2), towards the upper ends of the upright members 310, although these should not strictly be necessary in most cases.

As can be seen then, the structural integrity of the frame 100 is able to be provided without the need of a substantial and bulky frame as per the prior art shown in FIG. 1. In this way, the accessible aperture provided by the gate is maximised, making the whole apparatus much easier to negotiate for all users.

The materials used to construct the frame are preferably tubular steel which can be treated, coated or painted to achieve the desired aesthetic result. The gate 400 can be constructed from any suitable material, such as tubular steel again, aluminium, wood or a plastics material.

The fourth embodiment has particular advantages in that it provides a wider aperture than is possible with either the prior art gates or the other embodiments of the invention. This is because the structural integrity needed to ensure that the gate is securely fitted in the stairwell, is achieved by concentrating the forces required to hold the frame in place along the horizontal member 320. This obviates the need to provide sturdier, and hence, bulkier, upright portions of the frame and thereby allowing for a wider aperture.

FIG. 10 shows a fifth embodiment of the invention, which is particularly suitable for use in a stairway situation, as described so far, or to bar access to a particular room. The fifth embodiment differs from the previous embodiment in that the lower member 500 is arranged in a way that allows the gate of the fifth embodiment to be installed in the doorway of a room to which access is to be controlled by means of the gate. For instance, many parents install safety gates not only at the top and bottom of a staircase, but also at the entrance to rooms such as kitchens, which may contain potentially hazardous objects or substances.

If a safety gate according to one of the previous embodiments were installed in such a situation, the lower horizontal member, which is positioned to address the problems of tripping on a staircase, would itself pose a serious trip hazard when used on a flat surface such as a regular floor or doorway. This is since the horizontal member in these embodiments is positioned a few centimeters above the horizontal surface on which the gate is mounted (i.e. a step).

In order to address this particular problem, the lower member 500 is arranged to extend along and adjacent to the floor for as much of its length as possible. In this way, the lower horizontal bar 500 of the present embodiment is able to provide both structural strength as described previously, in connection with the other embodiments, but also allows the safety gate to be fitted to an open doorway without presenting a trip hazard to users of the gate. Furthermore, a safety gate according to this embodiment of the invention may also be used in a staircase scenario as described previously, since the lower member 500 will simply sit adjacent the riser of the adjacent step.

By positioning the end of the member 500 between the pressure fitting arrangement 330, as shown in FIG. 10, and then having the majority of the length of the member 500 deviating downwards to run along the floor, the lower member 500 is able to offer the required structural integrity to the gate, as described previously. whilst positioning the lower member 500 in a position whereby it runs along the floor thus minimising the possibility of a user tripping over it, when the gate is located in a doorway.

The arrangement shown in FIG. 10 may be used in a doorway or on the stairs, and by adjustment of the lower height adjusting members 370, a user of the arrangement is able to adjust the configuration so that the lower member 500 may be positioned optimally in relation to either a staircase or a doorway.

Although not shown in FIG. 10, the lower portion of the gate 400 can be shaped to follow and conform to the profile of the lower member 500, so that the gap between the gate and lower member 500 can be made to conform to ant desired specification.

In all of the embodiments described, it is possible that more than one horizontal member is provided, in order to provide additional structural integrity, provided, of course, that any such additional horizontal member is positioned below the step so as not to pose a trip hazard.

Clearly, embodiments of the invention offer a distinct improvement over prior art stair gates, offering the flexibility of a temporary-fit stair gate, combined with the ease of use and safety of a permanent-fit gate.

A user of an embodiment of the invention will find it as easy to fit as a prior art temporary-fit gate, and will benefit from the absence of a potentially dangerous trip hazard.

Features of the different embodiments disclosed may be combined in any permutation. Indeed, it may be possible to supply a single assembly arranged to implement any one of the embodiments disclosed herein with no material alteration required to the frame or gate.

Although the embodiments disclosed herein comprises a hinged gate arrangement, the invention may be embodied with a gate comprising a roller arrangement. In such an arrangement, the gate resembles a roller blind where the roller is arranged vertically on one side of the frame and the gate is closed by extending the material of the roller towards the other side of the frame, where it may be locked securely in position.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A safety gate assembly for positioning on a step of a flight of stairs and for impeding access to the flight of stairs, the assembly comprising:
a frame, arranged to span an entry to the flight of stairs; and
a gate, attached to the frame and movable between a closed position, where access to the flight of stairs is barred, and an open position, where the stairs are accessible,
wherein the frame comprises a pair of substantially upright, generally parallel, members for engagement with the parts of the flight of stairs and/or the wall or walls adjacent to it, and a substantially horizontal member, linking the upright members such that the frame is generally u-shaped and the substantially horizontal member is arranged to be position, in use, below the surface of the step.

2. A safety gate assembly as claimed in claim 1 wherein the substantially horizontal member is attached to each of the substantially upright members by a curved member, such that, in use, the curved member surrounds a nose of the step.

3. A safety gate assembly as claimed in claim 1 wherein the frame comprises a plurality of pressure-fit members for securely positioning the assembly in position.

4. A safety gate assembly as claimed in claim 3 wherein the pressure-fit members comprise a threaded screw portion terminated in a resilient material, whereby the threaded portion may be adjusted to ensure a secure fit of the frame in position.

5. A safety gate assembly as claimed in claim 1 further comprising a pressure-fit member located on the substantially horizontal member for contact with an underside of the step.

6. A safety gate assembly as claimed in claim 1 wherein the substantially horizontal member comprises a pair of pressure-fit members located at either end of the substantially horizontal member.

7. A safety gate as claimed in claim 1 wherein the gate is attached by a hinge arrangement to the frame.

8. A safety gate assembly as claimed in claim 7 wherein the gate is arranged to open in one direction only.

9. A safety gate assembly as claimed in claim 1 wherein the gate comprises a roller arrangement whereby the gate is closed by extending the material of the roller such that it spans the frame.

10. A safety gate as claimed in claim 1 wherein each substantially upright member comprises a pair of pressure attachment members, located respectively above and below the substantially horizontal member.

11. A safety gate as claimed in claim 10, wherein each substantially upright member further comprises a pressure attachment member at its upper end.

12. A safety gate assembly as claimed in claim 1 wherein the assembly comprises one of a substantially tubular steel construction, a pressed steel construction, an extruded aluminium construction, a cast aluminium construction, a formed plywood construction or a moulded/extruded plastics material construction.

13. A safety gate as claimed in claim 1 wherein the substantially horizontal member is arranged to be positioned adjacent to a substantially flat surface for a substantial portion of its length, such that the safety gate may be positioned in a doorway.
